(19) United States
(12) Patent Application Publication
(10) Pub. No.: US 2015/0273644 A1
(43) Pub. Date: Oct. 1, 2015

(54) CHUCK

(71) Applicant: Roehm GmbH, Sontheim/Brenz (DE)

(72) Inventor: Christian NEUBAUER, Moenchsdeggingen (DE)

(73) Assignee: Roehm GmbH, Sontheim/Brenz (DE)

(21) Appl. No.: 14/671,386

(22) Filed: Mar. 27, 2015

(30) Foreign Application Priority Data
Mar. 27, 2014 (DE) 10 2014 104 285.9

(51) Int. Cl. B23Q 17/00; B23B 31/16

(52) U.S. Cl. CPC B23Q 17/005; B23B 31/16; B23B 2231/26; B23B 2260/128

(57) ABSTRACT

A chuck having a chuck body in which clamping jaws are movably carried in radially extending guide seats. The clamping jaws include a base jaw and a top jaw arranged on the base jaw in a tongue and groove, and include at least one sensor for sensing the clamping force, whereby the sensor is associated with the tongue and groove.

This nonprovisional application claims priority under 35 U.S.C. §119(a) to German Patent Application No. 10 2014 104 285.9, which was filed in Germany on Mar. 27, 2014, and which is herein incorporated by reference.

### BACKGROUND OF THE INVENTION

1. Field of the Invention

The present invention relates to a chuck having a chuck body in which clamping jaws are movably carried in radially extending guide seats, which clamping jaws include a base jaw and a top jaw arranged on the base jaw in a tongue and groove, and having at least one sensor for sensing the clamping force, which sensor is associated with one of the clamping jaws.

2. Description of the Background Art

In modern machine tools, the machine spindles can be operated at very high rotational speeds, which shortens machining times significantly, and thus improves productivity considerably. However, the fundamental problem arises in both internal clamping and external clamping that the clamping force exerted on the workpiece is changed, and particularly in the case of external clamping is reduced by centrifugal force, with the result that secure gripping is not always ensured. One way to take this into account is to increase the initial clamping force to the extent that a minimum clamping force remains ensured despite the losses in clamping force induced by centrifugal force. This is unsatisfactory for safety reasons, however, so sensors that detect the actual clamping force in effect are placed in the force transmission chain for adjusting the clamping jaws so that the sensor signal is supplied to a control loop in order to compensate for any variation in the clamping force.

### SUMMARY OF THE INVENTION

It is therefore an object of the present invention to provide/to design a chuck of the initially mentioned type such that the placement of the sensor does not impair the transmission of the clamping force and the gripping of the workpiece by the clamping jaws.

This object is attained in an exemplary embodiment according to the invention in a chuck in that the sensor is associated with the tongue and groove.

The sensor can be positioned in the interface between the base jaw and the top jaw, and consequently does not impair the contact of the clamping jaw with the workpiece. As a result, the option now exists, in particular, that the sensor is not integrated directly in the force transmission chain, but instead is located parallel thereto, in that the change is detected in a component located in the force transmission chain.

In an embodiment, in the tongue and groove, which is composed of a groove and cross web that are perpendicular to one another in one of the two jaws, either the base jaw or top jaw, with corresponding structures in the other of the two jaws, the sensor can be associated with the surface of the cross web facing the other jaw. In the force transmission chain, the force from the base jaw is namely introduced into the clamping jaws, and from there to the workpiece, with compressive forces acting on the cross web in the radial direction of the chuck; these forces bring about a deformation of the cross web and can be detected by the sensor.

The sensor can be located on the base jaw, since the option then exists for the base jaw to be operated with any desired top jaws without the possibility of impairment of the measurement of the clamping force, or in other words the option exists of exchanging the top jaws.

In an exemplary embodiment, the sensor can be composed of a strain gage, and in particular for the sensor to be composed of a sensor film made of a support substrate in which the strain gage measurement structure is formed. With this type of sensor, it is possible to attach it to the tongue and groove by laser welding, for example, without great thermal stress occurring on the jaw as a whole.

Furthermore, it is also possible that the sensor film can be associated with the cross web on which the measuring structure is formed directly by sputtering and photolithography. There is thus no absolute necessity to produce the base jaw and sensor film separately and then join them together, but instead it is possible to implement the sensor film itself as an integral component of the jaw. In this context, it is thus also advantageous for the cross web to be formed on a tenon block that can be positioned in the jaw. This offers the advantage that only the tenon block has to be inserted into the requisite coating system for direct structuring, which is to say that insertion of the considerably more voluminous jaw is avoided. A tenon block can also be used with a welded sensor film, however, and not solely with direct structuring.

In an embodiment, since a cuboid tenon block is not rigid enough, the deformation is only partially sensed by the sensor, with the result that the tenon block has stiffening strips to increase its rigidity, and in particular has a T-shape.

Additional provision can be made within the scope of the invention that an actuator is provided between the base jaw and top jaw for the purpose of fine adjustment; using it, the sensor's quiescent signal or bridge zero signal, in particular, can be adjusted.

Additional provision can be made within the scope of the invention that a telemetry unit is provided for contactless transmission of energy and data, or that an electric storage cell and a radio module are associated with the base jaw.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a chuck according to the invention with base jaws and top jaws installed;

FIG. 2 is a longitudinal section through the chuck from FIG. 1;

FIG. 3 is an isolated view of the base jaw and top jaw from FIG. 2;

FIG. 4 is a perspective view of the isolated base jaw;

FIG. 5 is a view corresponding to FIG. 3 of an alternative embodiment of the base jaw and top jaw;

FIG. 6 is a view corresponding to FIG. 4 of an alternative embodiment of a base jaw;

FIG. 7 is a view corresponding to FIG. 4 of an embodiment with welded-on sensor film;

FIG. 8 is a view corresponding to FIG. 4 of another alternative embodiment;

FIG. 9 is a perspective view of a top jaw with attached sensor film;

FIG. 10 is a perspective view of a base jaw;

FIG. 11 is an embodiment in a perspective view;

FIG. 12 is an embodiment in a perspective view;

FIG. 13 is an embodiment in a perspective view;

FIG. 14 is a view corresponding to FIG. 3 with the actuator;

FIG. 15 is a view corresponding to FIG. 8 with a tenon block made separately from the base jaw;

FIG. 16 is a cross-sectional view of a complete clamping jaw with tenon block, sensor film, and supply and signal line; and

FIG. 17 is a perspective view without top jaw or mounting screws.

### DETAILED DESCRIPTION

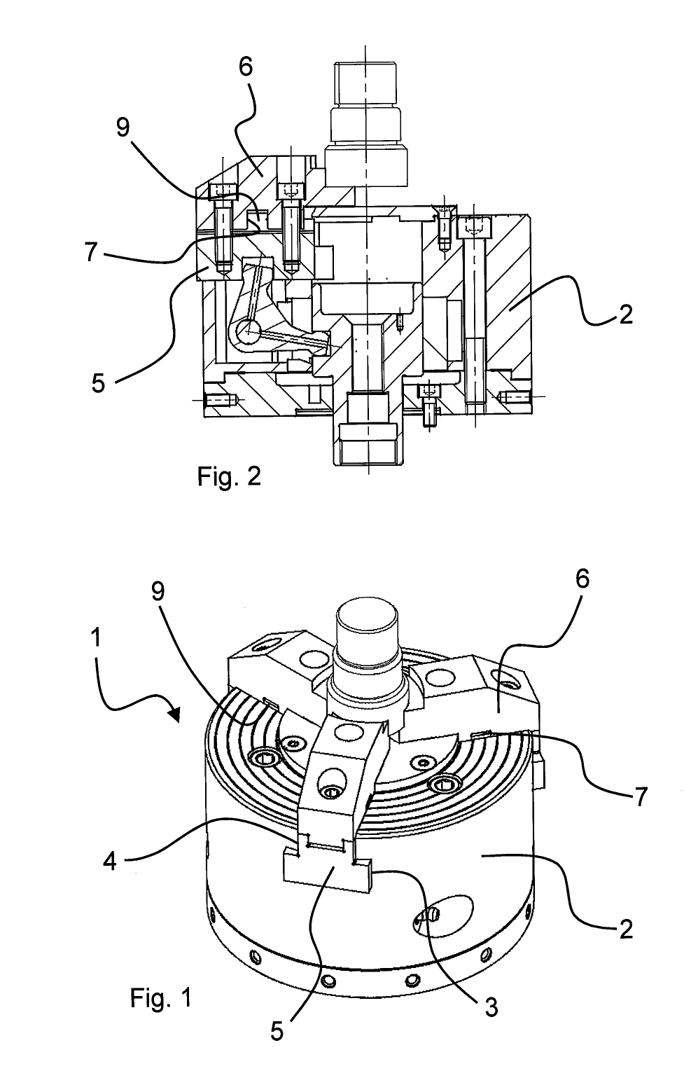

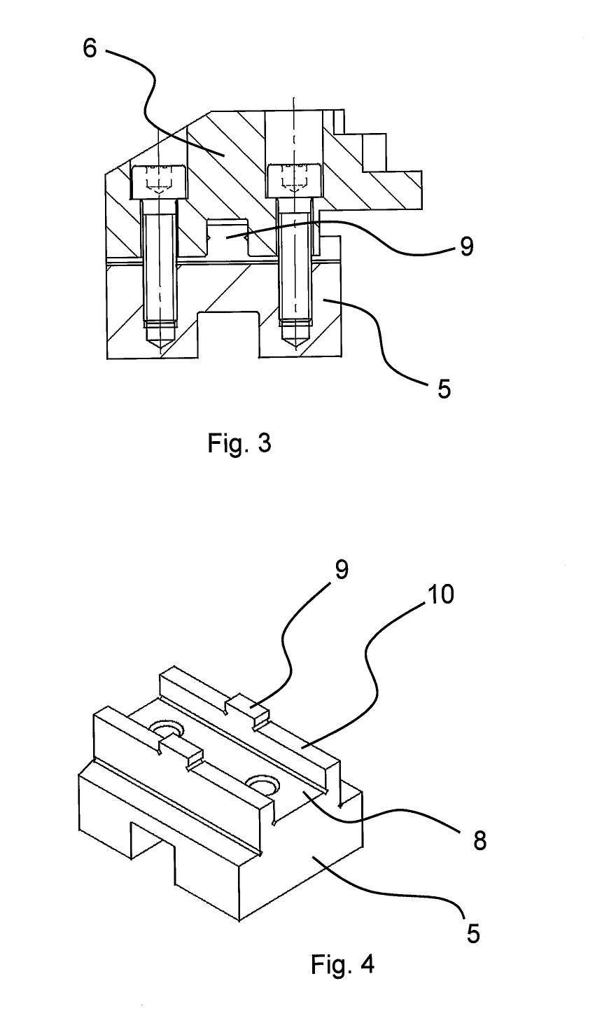

In the drawings, FIG. 1 shows a chuck 1 formed as a lever chuck with a low-hysteresis chuck body 2. In this chuck, clamping jaws 4 are carried in three radially extending guide seats 3, the clamping jaws being composed of a base jaw 5 and a top jaw 6 that is arranged on the base jaw 5 in a tongue and groove 7. The tongue and groove 7 is composed here of grooves 8 and cross webs 9 that are perpendicular to one another in one of either the base jaw 5 or top jaw 6, with corresponding structures in the other jaw. In the embodiment shown in FIGS. 3 and 4, the groove 8 is formed in the base jaw 5 with groove walls 10, and the cross web 9 formed on the walls.

In order to detect the clamping force, a sensor 11 is associated with the clamping jaw 4, and specifically with the tongue and groove 7. In this context, the possibility exists of the sensor being associated with either the base jaw 5 or the top jaw 6, with the design on the base jaw 5 offering the advantage that the top jaws 6 can be exchanged without impairing detection of the clamping force. The sensor 11 is composed of a strain gage 12, which can, in a conventional design, simply be positioned on the cross web 9 by gluing.

The sensor 11 can be composed of a sensor film 13 as a thin film structure that can be attached to the cross web 9 by laser welding, wherein the sensor film 13 has a support substrate that is 0.1 to 0.2 mm thick and made of a metal film, in which the strain gage measuring structure is applied by sputtering and photolithography. Alternatively, attachment by gluing is likewise possible.

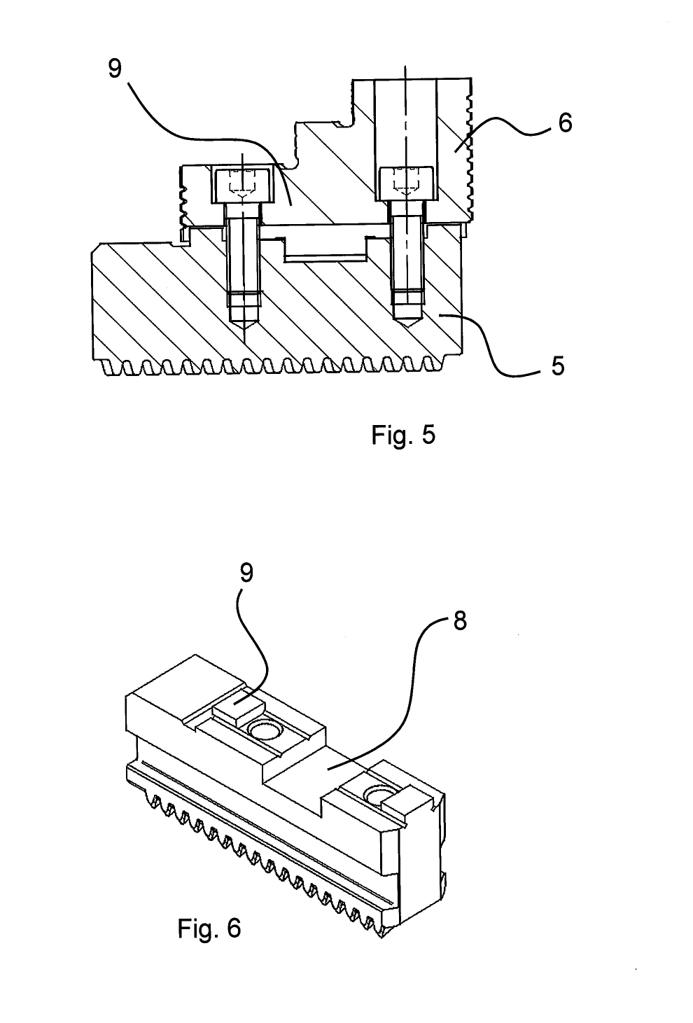

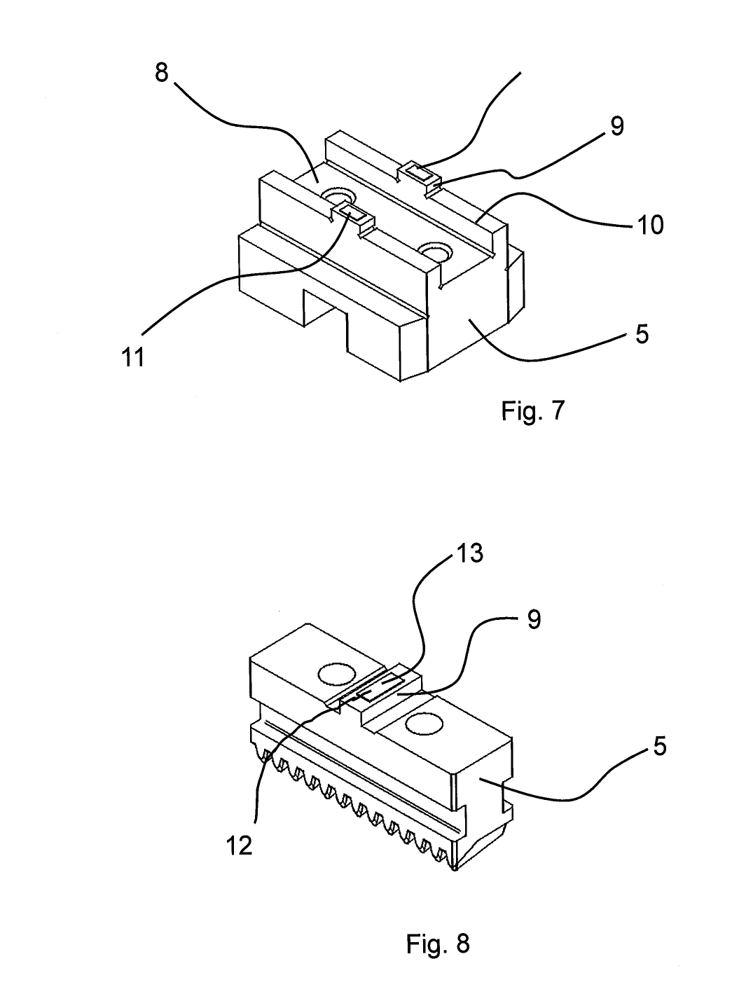

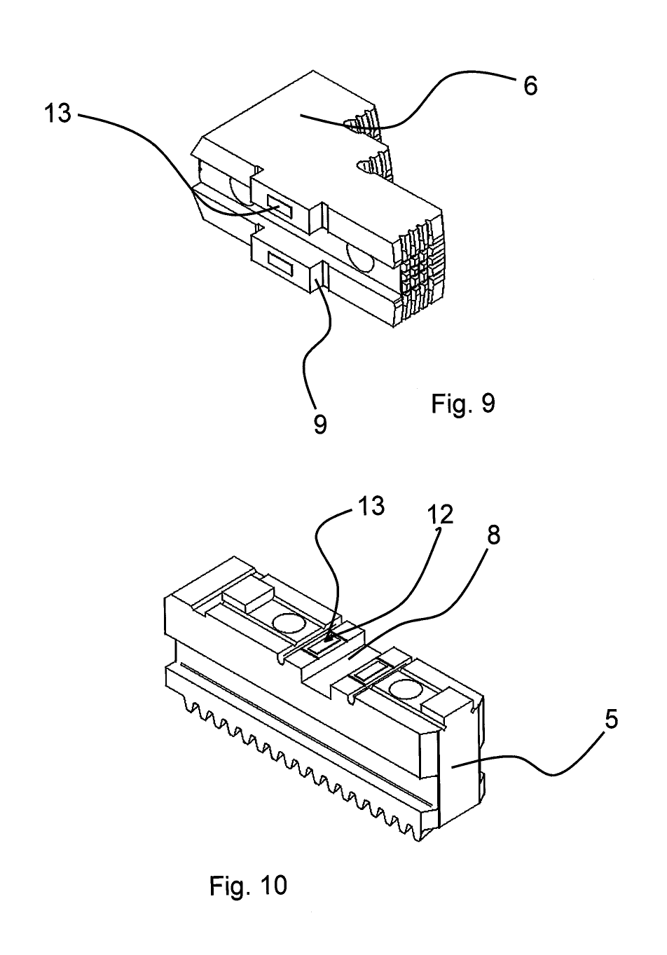

FIG. 4 to 15 show the different locations on the base jaw 5 or the top jaw 6 where the sensor film 13 can be positioned, namely on the cross web 9 of the tongue and groove 7 of a base jaw 5 or on the cross web 9 of the tongue and groove 7 of a top jaw 6. In general, it is also possible to provide for placement in the region of the groove 8 or to use multiple sensors 11 or sensor films 13. Dimensioning of the measuring body, namely of, for example, the cross web 9, must be designed such that sufficiently great deformation, and thus linear and transverse strain, occurs at the maximum force. The shape of the tongue and groove 7 can also be adapted to achieve the requisite strains.

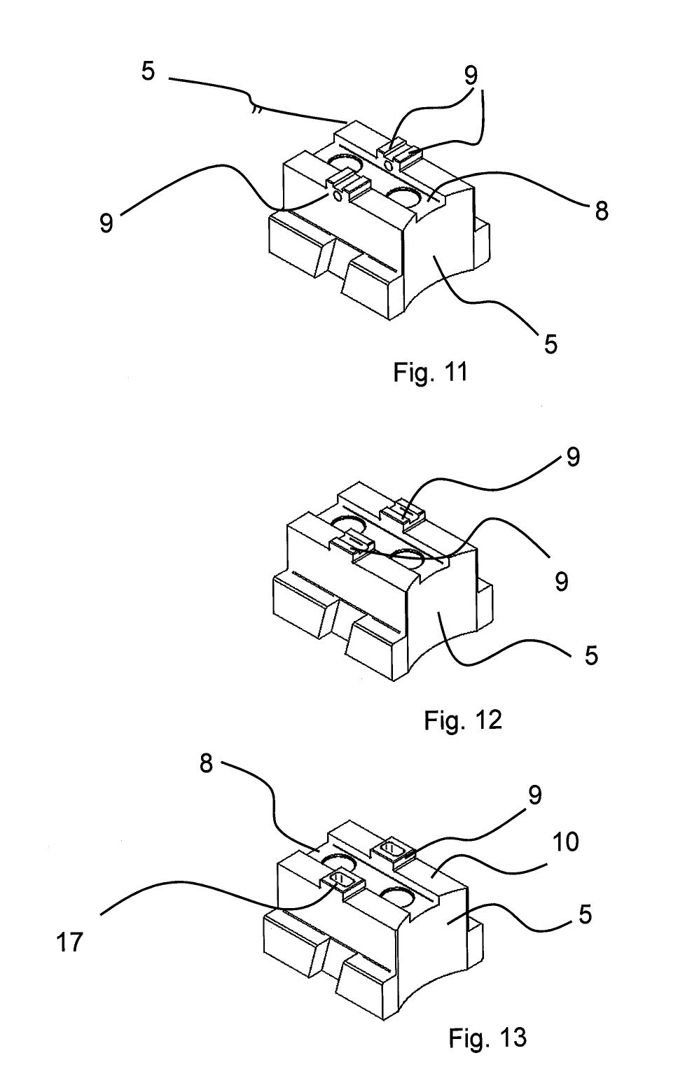

FIGS. 11-13 illustrate how the rigidity of the cross web, and hence the sensitivity of the sensor film (not shown) located thereon, is influenced by additional longitudinal and transverse grooves. In addition, supply and signal lines can be routed directly to the thin film structure of the sensor film 13 through holes.

Alternatively, this offers the option of attaching the sensor film with the thin film structure on the bottom. In this way, the thin film structure and its contact points with the soldered-on lines are protected from the outside, and can in addition be potted. A telemetry unit is provided for transmission of energy and data from the rotating chuck 1 (FIG. 17).

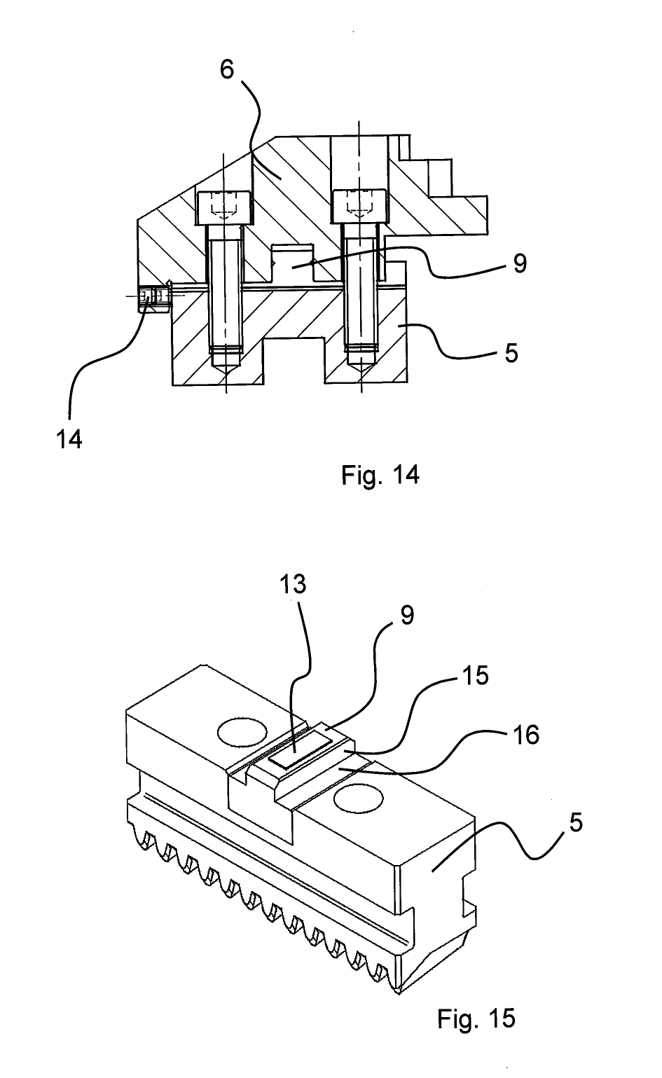

In the exemplary embodiment shown in FIG. 14, an adjusting screw 14 is present, with which the position of the top jaw 6 relative to the base jaw 5 can be adjusted so as to achieve defined initial conditions when aligning the base jaw 5 and top jaw 6.

FIG. 15 shows that the sensor film 13 does not exclusively have to be welded directly onto the cross web 9 of a base jaw 5 or top jaw 6. Instead, the sensor film 13 can also be mounted on a tenon block 15 for economic as well as production and assembly reasons.

It is not strictly necessary for the sensor film 13 to be produced separately and then attached to the base jaw 5 by laser welding, since it is also possible to form the thin film structures required for implementing the sensor film 13 directly on the jaw. Since direct structuring of a complete base jaw 5 generally is out of the question on account of costly installation space in the coating facilities, it is possible to use an inherently rigid tenon block 15 that is designed in a T-shape, which is to say that has stiffening strips 16, and that is then fastened in the jaw.

Alternatively, it is possible to associate an electric storage cell and a radio module with the base jaw 5 in order to transmit the data acquired by the sensor 11 to a stationary system.

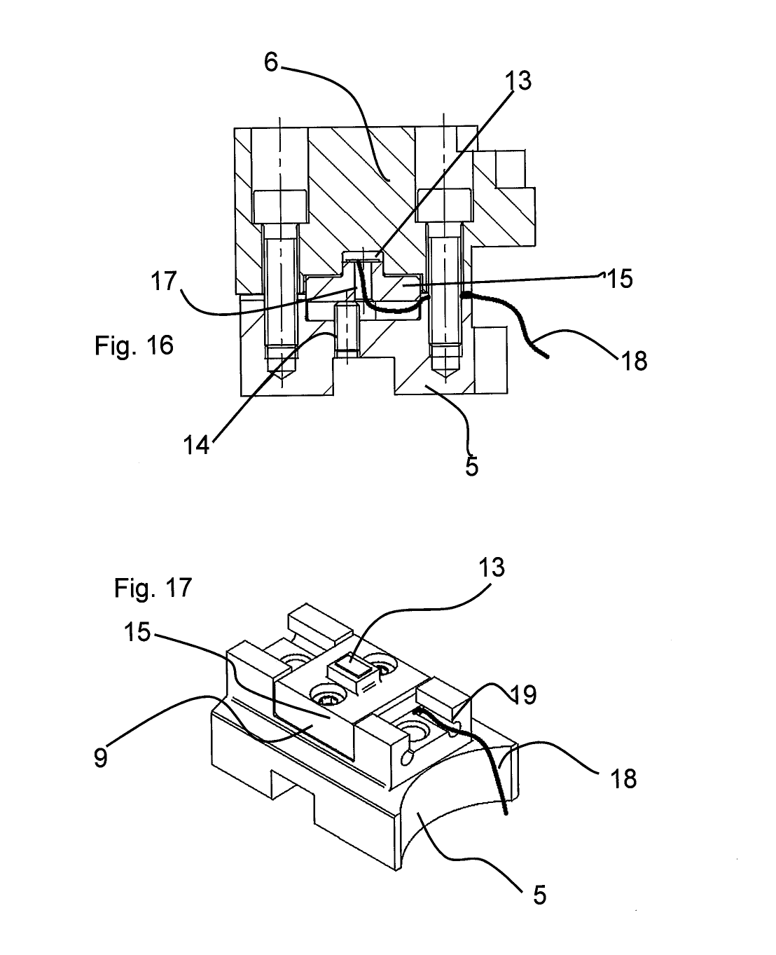

FIG. 16: In addition, fine adjustment via actuators in the base jaw 5 is possible when a tenon block 15 is employed.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A chuck comprising:
a chuck body in which clamping jaws are movably carried in radially extending guide seats, which clamping jaws are composed of a base jaw and a top jaw arranged on the base jaw in a tongue and groove; and
at least one sensor for sensing a clamping force, the sensor being associated with one of the clamping jaws, the sensor being associated with the tongue and groove.

2. The chuck according to claim 1, wherein, in the tongue and groove, which is composed of a groove and cross web that are perpendicular to one another in one of the two jaws, either the base jaw or top jaw with corresponding structures in the other of the two jaws, the sensor is associated with the surface of the cross web facing the other jaw.

3. The chuck according to claim 2, wherein the sensor is located on the base jaw.

4. The chuck according to claim 1, wherein the sensor is a strain gage.

5. The chuck according to claim 1, wherein the sensor is a sensor film made of a support substrate in which a strain gage measurement structure is formed.

6. The chuck according to claim 5, wherein a cross web is formed on a tenon block that is positionable in the jaw.

7. The chuck according to claim 5, wherein the sensor film is associated with the cross web on which the measuring structure is formed directly by sputtering and photolithography.

8. The chuck according to claim 1, wherein holes and recesses are placed in the cross web through which supply and signal lines are routed for contacting downward-facing measuring structures.

9. The chuck according to claim 6, wherein the tenon block has stiffening strips.

10. The chuck according to claim 2, wherein an actuator is provided between the base jaw and the top jaw or a tenon block for fine adjustment.

11. The chuck according to claim 1, further comprising a telemetry unit for contactless transmission of energy and data.

12. The chuck according to claim 1, wherein an electric storage cell and a radio module are associated with the base jaw.
